(19) United States
(12) Patent Application Publication
(10) Pub. No.: US 2025/0249316 A1
(43) Pub. Date: Aug. 7, 2025

(54) FOAM BALL HAVING LIGHT-EMITTING SKELETON

(71) Applicant: Blackstar Corp., Taipei City (TW)

(72) Inventor: WEI-HUNG LIN, Taipei City (TW)

(21) Appl. No.: 18/826,621

(22) Filed: Sep. 6, 2024

(30) Foreign Application Priority Data
Feb. 7, 2024 (TW) 113104863

(51) Int. Cl. A63B 43/06; A63B 37/06; F21V 7/00; F21V 33/00; F21Y 115/10

(52) U.S. Cl. CPC A63B 43/06; A63B 37/06; F21V 7/0025; F21V 33/008; A63B 2037/065; A63B 2225/74; A63B 2225/76; F21Y 2115/10

(57) ABSTRACT

A foam ball having a light-emitting skeleton includes the light-emitting skeleton and a foam sphere. The light-emitting skeleton includes a light source device and a light body. The light body is in connection with the light source device, and the light body is configured to emit light. The foam sphere is formed by a foam material and covers the light-emitting skeleton to enable at least a portion of the light body to be disposed on a surface of the foam sphere.

### CROSS-REFERENCE TO RELATED PATENT APPLICATION

This application claims the benefit of priority to Taiwan Patent Application No. 113104863, filed on Feb. 7, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a ball, and more particularly to a foam ball having a light-emitting skeleton.

### BACKGROUND OF THE DISCLOSURE

Balls made of a foam material are commercially available, and have the advantage of being safe for use. Furthermore, such balls are suitable for use by both children and adults. However, due to the low light transmittance of the foam material, disposing a light source in the foam material is unsuitable, which greatly reduces the enjoyment of using the ball made of the foam material at night or in an environment with insufficient lighting.

### SUMMARY OF THE DISCLOSURE

In response to the above-referenced technical inadequacies, the present disclosure provides a foam ball having a light-emitting skeleton.

In order to solve the above-mentioned problems, one of the technical aspects adopted by the present disclosure is to provide a foam ball. The foam ball includes a light-emitting skeleton and a foam sphere. The light-emitting skeleton includes a light source device and a light body. The light body is in connection with the light source device, and the light body is configured to emit light. The foam sphere is formed by a foam material and covers the light-emitting skeleton to enable at least a portion of the light body to be disposed on a surface of the foam sphere.

In one of the possible or preferred embodiments, the light body is a strip-shaped or sheet-shaped LED lamp.

In one of the possible or preferred embodiments, the light body is a strip-shaped or sheet-shaped cold light.

In one of the possible or preferred embodiments, the light body is a strip-shaped or sheet-shaped light guide.

In one of the possible or preferred embodiments, the light body is formed by a plurality of optical fibers.

In one of the possible or preferred embodiments, the light body is bendable, and two ends of the light body are connected to the light source device.

In one of the possible or preferred embodiments, a plurality of light-guiding branches that are elongated extend outward from the light body.

In one of the possible or preferred embodiments, the light source device includes a light-emitter, a power supply, and a main controller, and the main controller is electrically coupled with the light-emitter and the power supply. The main controller includes a main control circuit board, the power supply includes at least one battery that is disposed on the main control circuit board, and the light-emitter includes at least one light-emitting diode that is disposed on the main control circuit board.

In one of the possible or preferred embodiments, the light-emitting skeleton further includes a reflector that is disposed on the light-emitting skeleton and that is capable of reflecting external light.

In one of the possible or preferred embodiments, the reflector includes a first reflective film, a second reflective film, and a light-transmitting film, the light-transmitting film is disposed on the first reflective film, the first reflective film is disposed on the second reflective film, and a surface area of the second reflective film is greater than a surface area of the first reflective film.

In one of the possible or preferred embodiments, the reflector includes a first reflective film, a second reflective film, a third reflective film, and a light-transmitting film, the first reflective film is disposed on the second reflective film, and the second reflective film is disposed on the third reflective film. A plurality of first windows are formed on the first reflective film to reveal the second reflective film, and a plurality of second windows are formed on the second reflective film to reveal the third reflective film.

In one of the possible or preferred embodiments, the reflector includes a first reflective film and a light-transmitting film, the light-transmitting film is disposed on the first reflective film through a light-transmitting adhesive layer, and the light-transmitting adhesive layer is a mixture of one or more types of powder.

Therefore, in the foam ball having a light-emitting skeleton provided by the present disclosure, by virtue of “the light-emitting skeleton including a light source device and a light body,” and “the foam sphere being formed by a foam material and covering the light-emitting skeleton to enable at least a portion of the light body to be disposed on a surface of the foam sphere,” a manufacturing time for the foam ball can be reduced, and the enjoyment of using the foam ball at night or in an environment with insufficient lighting is not limited by the insufficient light transmittance of the conventional foam ball.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of a foam ball according to one embodiment of the present disclosure;

FIG. 2 is a schematic cross-sectional view taken along line II-II of FIG. 1;

FIG. 3 is a schematic diagram of a light-emitting skeleton of the foam ball according to one embodiment of the present disclosure;

FIG. 4 is a schematic top view of light-guiding branches of the foam ball according to one embodiment of the present disclosure;

FIG. 5 is a schematic top view of a reflector of the foam ball according to one embodiment of the present disclosure;

FIG. 6 is a schematic structural diagram of the reflector of the foam ball according to one embodiment of the present disclosure;

FIG. 7 is another schematic structural diagram of the reflector of the foam ball according to one embodiment of the present disclosure;

FIG. 8 is yet another schematic structural diagram of the reflector of the foam ball according to one embodiment of the present disclosure;

FIG. 9 is another schematic side view of the foam ball according to one embodiment of the present disclosure; and

FIG. 10 is a perspective schematic diagram of the foam ball according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### EMBODIMENTS

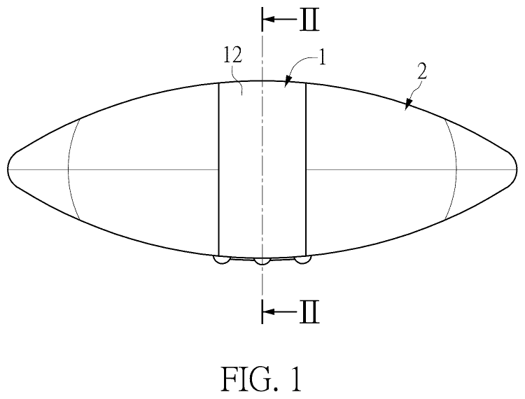

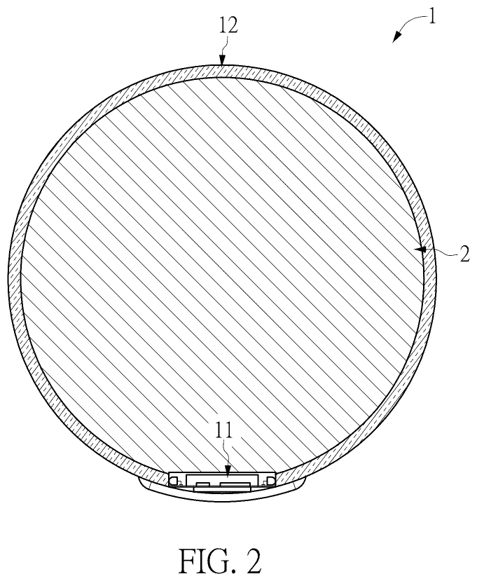

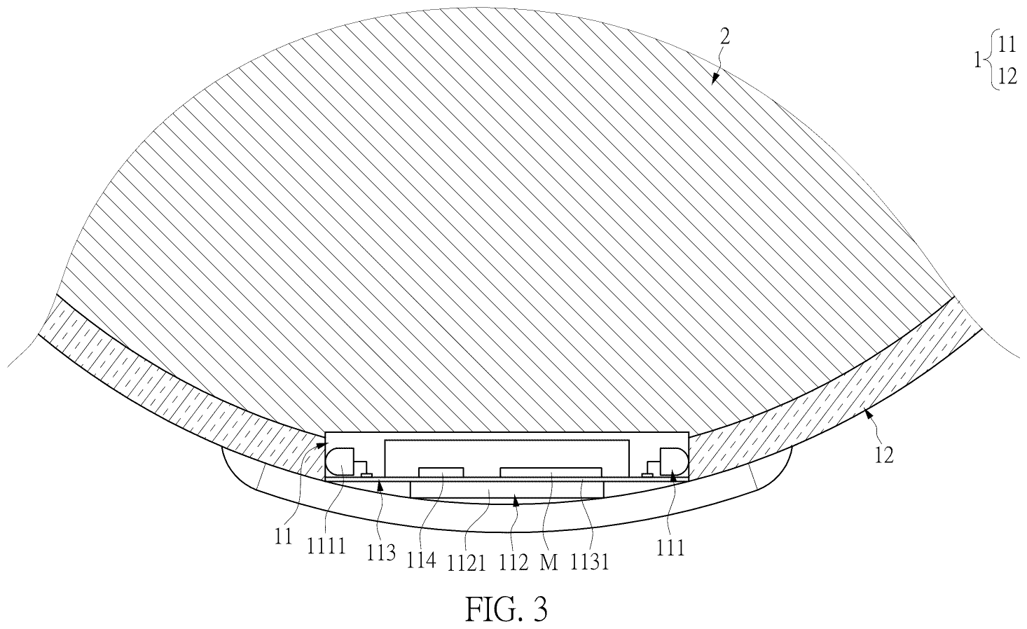

Referring to FIG. 1 to FIG. 3, one embodiment of the present disclosure provides a foam ball having a light-emitting skeleton, and the foam ball essentially includes a light-emitting skeleton 1 and a foam sphere 2.

The light-emitting skeleton 1 includes a light source device 11 and a light body 12. The light body 12 is in connection with the light source device 11, and the light body 12 can emit light. The light body 12 can be a strip-shaped or sheet-shaped LED lamp, a strip-shaped or sheet-shaped cold light, a strip-shaped or sheet-shaped light guide, or formed by a plurality of optical fibers. The foam sphere 2 is formed by a foam material and covers the light-emitting skeleton 1 to enable at least a portion of the light body 12 to be disposed on a surface of the foam sphere 2, i.e., at least a portion of the light body 12 can be exposed from or near the surface of the foam sphere 2. By using the foam material to form different types of spheres (e.g., a rugby ball or a soccer ball) on the pre-prepared light-emitting skeleton 1 and having at least a portion of the light body 12 to be disposed on the surface of the foam sphere 2, the manufacturing speed can be increased, and the enjoyment of using the foam ball at night or in an environment with insufficient lighting is not limited by the insufficient light transmittance of the foam sphere 2.

In this embodiment, the light body 12 can be a strip-shaped or sheet-shaped light guide, the light body 12 is bendable, and two ends of the light body 12 are connected to the light source device 11. Therefore, light emitted by the light source device 11 may travel into the light body 12 and be reflected within the light body 12 to fill up the entire light body 12, such that the entire light body 12 is illuminated. The light source device 11 can include a light-emitter 111, a power supply 112, and a main controller 113, and the main controller 113 is electrically connected to the light-emitter 111 and the power supply 112. The main controller 113 can include a main control circuit board 1131, and one or more microprocessors M and components such as resistors or capacitors can be disposed on the main control circuit board 1131. The light-emitter 111 can include at least one light-emitting diode 1111, and the light-emitting diode 1111 can be disposed on a front or rear side of the main control circuit board 1131. The power supply 112 can include at least one battery 1121, and the battery 1121 can be disposed on the front or rear side of the main control circuit board 1131. Preferably, the battery 1121 can exemplarily be a coin-cell battery (e.g., a CR-2032 coin-cell lithium battery), and multiple batteries 1121 can be disposed in a stack. In this embodiment, the light source device 11 can further include a shaking switch 114 that is in electrical connection with the main controller 113, the shaking switch 114 can be disposed on the front or rear side of the main control circuit board 1131, and the shaking switch 114 can be used to sense a shaking. When the shaking is sensed, the shaking switch 114 can be switched-on to control the light-emitting diode 1111 to be switched-on, and when the shaking is not sensed after a predetermined period of time has elapsed, the shaking switch 114 can be switched-off to control the light-emitting diode 1111 to be switched-off, thereby extending the battery life of the battery 1121. In addition, the main controller 113 can further have a backup power supply mode, such that when one of the light-emitting diodes 1111 is damaged, the remaining light-emitting diodes 1111 are still lit.

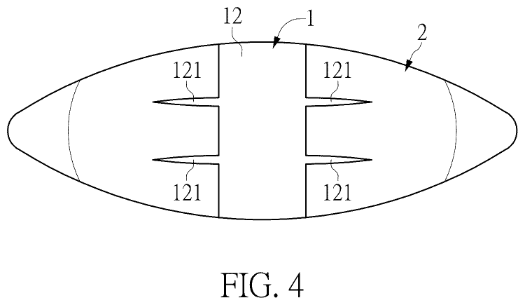

In one embodiment, as shown in FIG. 4, a plurality of light-guiding branches 121 that are elongated extend outward from the light body 12 of the light-emitting skeleton 1, such that light can be transmitted outwardly from the light body 12 to the light-guiding branches 121 to improve the light-guiding effect.

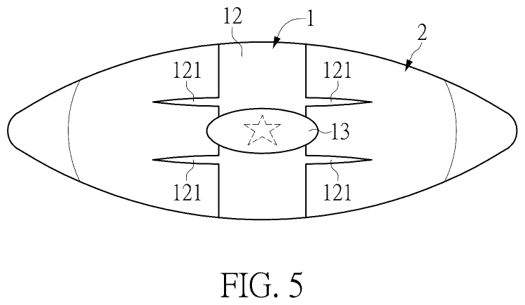

In one embodiment, as shown in FIG. 5, the light-emitting skeleton 1 further includes a reflector 13 that can be disposed on the light body 12, and the reflector 13 is capable of reflecting external light (e.g., ambient light) to have a reflective effect. Therefore, the foam sphere 2 can guide internal light to the surface of the sphere through the light body 12, and can further reflect external light through the reflector 13, so as to produce a multi-layered lighting effect.

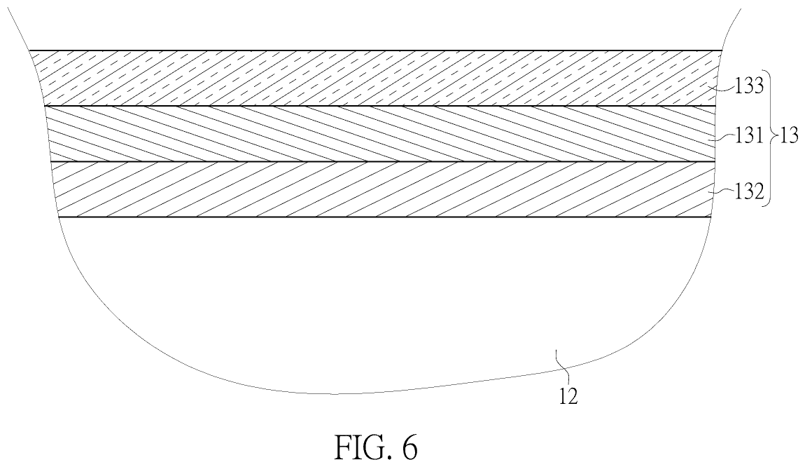

In one embodiment, as shown in FIG. 6, the reflector 13 includes a first reflective film 131, a second reflective film 132, and a light-transmitting film 133, and the first reflective film 131 and the second reflective film 132 can respectively be a film having multiple glass microbeads. Therefore, when external light is irradiated on the first reflective film 131 and the second reflective film 132, the first reflective film 131 and the second reflective film 132 may produce a high-brightness reflective effect. Moreover, text or patterns can be printed on the surfaces of the first reflective film 131 and the second reflective film 132 by coating or printing. The first reflective film 131 and the second reflective film 132 have different text, patterns, colors, and different surface areas, and a surface area of the second reflective film 132 can be greater than a surface area of the first reflective film 131, so as to produce colorful composite patterns.

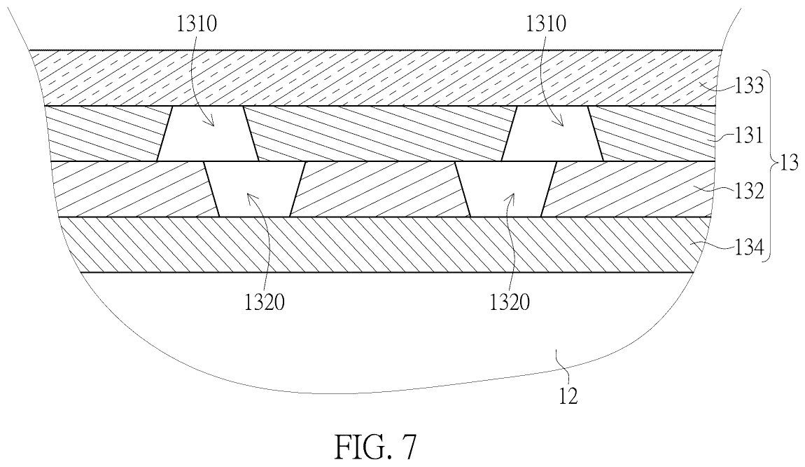

In one embodiment, as shown in FIG. 7, the reflector 13 includes a first reflective film 131, a second reflective film 132, a third reflective film 134, and a light-transmitting film 133. A plurality of first windows 1310 are formed on the first reflective film 131 to reveal the second reflective film 132, and a plurality of second windows 1320 are formed on the second reflective film 132 to reveal the third reflective film 134, thereby allowing different patterns and colors of the first reflective film 131, the second reflective film 132, and the third reflective film 134 to be viewed through the light-transmitting film 133.

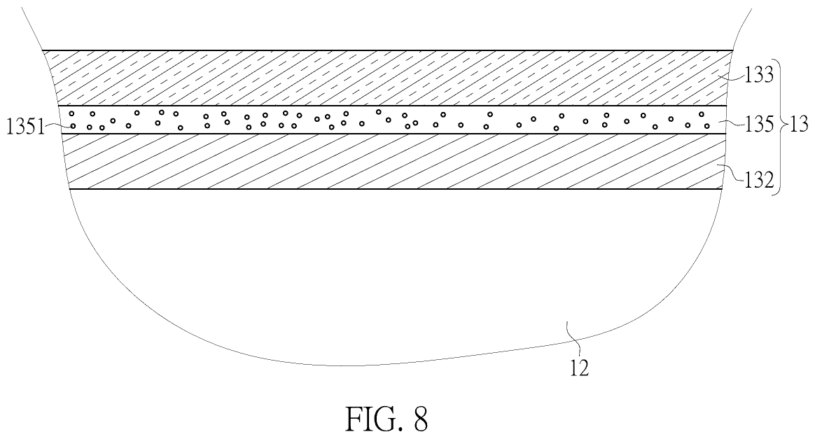

In one embodiment, as shown in FIG. 8, the reflector 13 includes a first reflective film 131 and a light-transmitting film 133, the light-transmitting film 133 is disposed on the first reflective film 131 through a light-transmitting adhesive layer 135, and the light-transmitting adhesive layer 135 is a mixture of one or more types of powder 1351 such as gold powder, silver powder, and pearlescent powder so as to increase the overall color brightness effect.

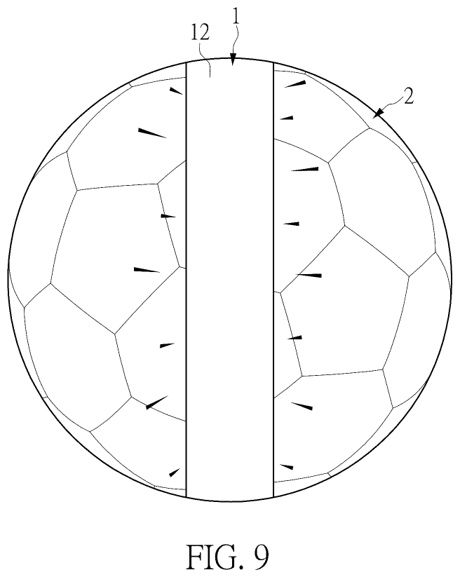

In one embodiment, as shown in FIG. 9, the foam sphere 2 is formed into a soccer ball by the foam material on the pre-prepared light-emitting skeleton 1, such that the light body 12 is exposed from the surface of the foam sphere 2.

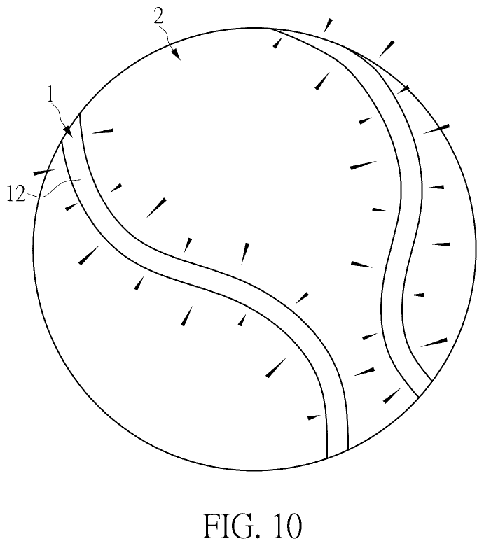

In one embodiment, as shown in FIG. 10, the foam sphere 2 is formed into a baseball by the foam material on the pre-prepared light-emitting skeleton 1, such that the light body 12 is exposed from the surface of the foam sphere 2.

### Beneficial Effects of the Embodiments

In conclusion, in the foam ball having a light-emitting skeleton provided by the present disclosure, by virtue of “the light-emitting skeleton including a light source device and a light body,” and “the foam sphere being formed by a foam material and covering the light-emitting skeleton to enable at least a portion of the light body to be disposed on a surface of the foam sphere,” a manufacturing time for the foam ball can be reduced, and the enjoyment of using the foam ball at night or in an environment with insufficient lighting is not limited by the insufficient light transmittance of the conventional foam ball.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A foam ball, comprising:
a light-emitting skeleton including a light source device and a light body, wherein the light body is in connection with the light source device, and the light body is configured to emit light; and
a foam sphere being formed by a foam material and covering the light-emitting skeleton to enable at least a portion of the light body to be disposed on a surface of the foam sphere.

2. The foam ball according to claim 1, wherein the light body is a strip-shaped or sheet-shaped LED lamp.

3. The foam ball according to claim 1, wherein the light body is a strip-shaped or sheet-shaped cold light.

4. The foam ball according to claim 1, wherein the light body is a strip-shaped or sheet-shaped light guide.

5. The foam ball according to claim 1, wherein the light body is formed by a plurality of optical fibers.

6. The foam ball according to claim 1, wherein the light body is bendable, and two ends of the light body are connected to the light source device.

7. The foam ball according to claim 1, wherein a plurality of light-guiding branches that are elongated extend outward from the light body.

8. The foam ball according to claim 1, wherein the light source device includes a light-emitter, a power supply, and a main controller, and the main controller is electrically coupled with the light-emitter and the power supply; wherein the main controller includes a main control circuit board, the power supply includes at least one battery that is disposed on the main control circuit board, and the light-emitter includes at least one light-emitting diode that is disposed on the main control circuit board.

9. The foam ball according to claim 1, wherein the light-emitting skeleton further includes a reflector that is disposed on the light body and that is capable of reflecting external light.

10. The foam ball according to claim 9, wherein the reflector includes a first reflective film, a second reflective film, and a light-transmitting film, the light-transmitting film is disposed on the first reflective film, the first reflective film is disposed on the second reflective film, and a surface area of the second reflective film is greater than a surface area of the first reflective film.

11. The foam ball according to claim 9, wherein the reflector includes a first reflective film, a second reflective film, a third reflective film, and a light-transmitting film, the first reflective film is disposed on the second reflective film, and the second reflective film is disposed on the third reflective film; wherein a plurality of first windows are formed on the first reflective film to reveal the second reflective film, and a plurality of second windows are formed on the second reflective film to reveal the third reflective film.

12. The foam ball according to claim 9, wherein the reflector includes a first reflective film and a light-transmitting film, the light-transmitting film is disposed on the first reflective film through a light-transmitting adhesive layer, and the light-transmitting adhesive layer is a mixture of one or more types of powder.
